(19) United States
(12) Patent Application Publication
(10) Pub. No.: US 2006/0138717 A1
(43) Pub. Date: Jun. 29, 2006

(54) Highly shock-resistant ceramic material

(76) Inventors: Gerhard Wotting, Coburg (DE); Bernhard Caspers, Vienenburg (DE); Jurgen Hennicke, Rodental (DE); Hans-Jurgen Thoma, Rodental (DE); Lutz Frassek, Rodental (DE)

Correspondence Address: BAYER MATERIAL SCIENCE LLC, 100 BAYER ROAD, PITTSBURGH, PA, 15205, US

(21) Appl. No.: 10/523,567

(22) PCT Filed: Jul. 24, 2003
(86) PCT No.: PCT/EP03/08143

§ 371 Date: Aug. 29, 2005

(30) Foreign Application Priority Data
Aug. 6, 2002 (DE) 102 35 965.2

(51) Int. Cl. C04B 35/584; C04B 35/565; C04B 35/48; C04B 35/56; C04B 35/00; C04B 35/64; B28B 1/00

(52) U.S. Cl. 264/683; 501/97.1; 501/103; 501/88; 264/603

(57) ABSTRACT

Ceramic material of high impact strength, in particular based on Si₃N₄ or ZrO₂, having an HV10 hardness of not more than 15.5 GPa and an E modulus at room temperature of less than 330 GPa, wherein the material contains 0.2 to 5 wt. % of carbon particles which have a maximum particle size of 5 μm, a process for the preparation of the ceramic material and the use thereof, in particular as roller bodies in bearings.

Ceramic materials are increasingly being used in all fields of industry where conventional materials encounter performance limits. This also applies to the field of bearings, where in the case of roller bearings in particular, silicon nitride (Si₃N₄) roller bodies have a large number of advantages over metallic roller bodies. Zirconium dioxide (ZrO₂) roller bodies are also of interest, since ZrO₂ has a thermal expansion similar to that of roller bearing steels and as a result there are no constructional design problems at higher temperatures.

One problem in respect of these roller bodies is that their impact strength is limited, and during production or use of high-precision bearing components, in particular bearing balls, damage may therefore occur, such as is described e.g. by Hadfield in “Failure of Silicon Nitride Rolling Elements with Ring Crack Defects” in: Ceramics International 24 (1998), 379-386 and by Cundill in “Impact Resistance of Silicon Nitride Balls” in: Proc. 6^{th} Int. Symp. on Ceramic Materials and Components for Engines, Arika, Japan, 1997, 556-561. Sickle-shaped surface cracks, so-called C cracks, thereby form, which grow under load during further use and can lead to chipping with the consequence of massive bearing damage. Such defects are of course undesirable.

Dense, largely pore- and defect-free silicon nitride is distinguished by a comparatively high impact strength compared with other ceramic materials due to the combination of favourable mechanical properties. However, as Hadfield and Cundill show, C cracks are also to be found in commercially available silicon nitride variants, inter alia those produced by hot isostatic pressing, and under load these may lead to cracking and therefore to premature failure, which illustrates the sensitivity in respect of such damage.

The cause of such damage is located in the field of contact mechanics, in that rigid bodies, i.e. materials in the region of their linear-elastic behaviour, exert such a high pressure on one another that the formation of these surface C cracks and subsequently the formation of cone-shaped defects, which spread more deeply into the material, occur.

The fundamental equations of contact mechanics were introduced by Hertz and are documented in many textbooks.

In the contact region between two spherical bodies, providing that both bodies have linear-elastic behaviour, for the highest surface pressure q₀:
q₀=3/2 P/(2πa)
where P is the compressive force and a is the radius of the contact area. The radius a of the contact area depends on the radii R₁ and R₂ of the two bodies and the elastic properties of elasticity modulus E and the Poisson ratio μ, known from strength science, of the material of the two bodies.

While the maximum surface pressure or compressive stress q₀ occurs in the centre of the contact area, the maximum tensile stress σᵣ, which is decisive for failure of brittle materials, develops at the edge of the contact area and is
σᵣ=(1-2μ)q₀/3

Damage to bodies in contact occurs if the tensile stresses exceed the tensile strength of the material.

The level of surface pressure which can be tolerated is determined in this context by a large number of characteristic values of the materials and structures, such as tensile and shear strength, toughness, elasticity and shear modulus, number and size of defects, these material- and also technology-specific characteristic values, which in some cases depend on one another, allowing no direct conclusion as to the preferred nature of an impact-resistant material.

The object of the invention was to provide ceramic materials having the highest possible impact strength.

For determination of the impact strength, in this context a simple but industrially established test method for determining the notched impact strength was used in a slightly modified form.

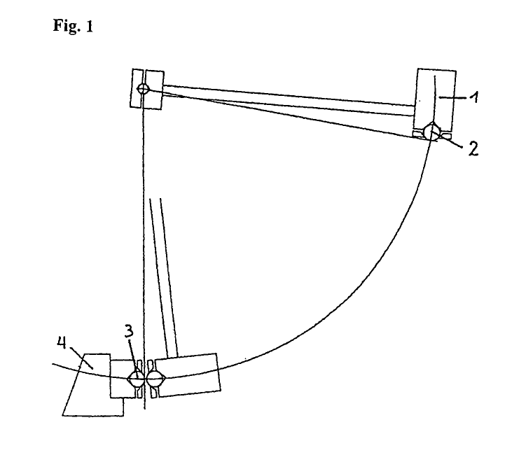

A pendulum impact tester from e.g. Zwick having an effective pendulum length of l=156 mm and a weight of the impact hammer of m=360 g was employed in this context. The pendulum impact tester is shown in diagram form in FIG. 1. In a depression in the hammer, the so-called ball seat (1), a ball (2) having e.g. a diameter D of 12.7 mm of bearing quality according to DIN 5401 of at least G25 or better is fixed with a counterpart. A ball (3) of equal size which is identical in respect of material and machining quality is likewise positioned in the abutment (4) of the pendulum impact tester in the same manner. Before being installed, the balls to be tested are investigated in respect of already existing defects by a dye penetration test. Only balls which are rated as defect-free by this method are used for the investigation. The impact speed and therefore the impact energy can be varied by varying the angle of deflection a. After each impact test, the position of the possible damaged area is marked on the two balls, the balls are then rotated through 90 degrees and a new test is carried out at the same angle of deflection α. 6 possible defects per ball, i.e. 12 in total, are produced in this manner. After the test, the number of defects on the balls is determined by a dye penetration test. High-precision roller bearing rolls or needles can be tested in the same manner.

In the method used by Cundill for determination of the impact strength by means of the free fall of a ball and impact of the ball on a second ball, the critical impact energy W_{c} which leads to the first formation of C cracks is calculated from the fall height h_{c}, the mass of the ball mₖ and the acceleration of gravity g as follows:
W_{c}=mₖg h_{c}=32Ea_{c}⁵/15R²

In this equation, a_{c} is the critical radius of the contact area. R is the radius of the ball in mm and E is the elasticity modulus in GPa.

In the pendulum impact tester described above, the impact energy W depends on the angle of deflection a and the mass ma of the impact arm and the pendulum length l:
W=g(1−cos α)mₐ l.
The mass mₐ and pendulum length l can be combined to an apparatus constant K. For the impact apparatus used (mass=360 g, pendulum length=156 mm) in the construction described (ignoring the relatively low mass of the ball):
K=0.0562 kg m.
Therefore, for the critical angle of deflection α_{c} at which the impact energy reaches the critical value W_{c}:
cos α_{c}=l−(32Ea_{c}⁵/15R²gK).
This test can therefore be evaluated to the extent of determining the critical angle of deflection α_{c} and from this the critical impact energy W_{c}, which characterizes the impact strength of the ball material.

For comparison tests, it is advisable to employ only one constant ball size, where the diameter should be ≧6 mm. A ball diameter of 15 mm is specified as the upper limit for appropriate use of this test.

It was found in preliminary tests that an angle of deflection α=40° corresponds to an impact energy which allows differentiation of the impact strength of various ball materials. The tests were in each case conducted with 6 impacts and the balls were examined in respect of the number of damaged areas. This is therefore purely a comparison test, 12 damaged areas (6 per ball) corresponding to 100% damage.

The most diverse ball materials, the composition and technological characteristic values of which varied widely, were tested in this manner. The material characteristics and the test results of the materials of the examples are summarized in Table 1.

Unless stated otherwise, the material characteristics and properties listed in Table 1 are determined as follows:

Sintered density:
This is determined by measuring the buoyancy in H₂O in accordance with Archimedes' principle.

Relative theoretical density:
This is a mathematical value based on the densities of the individual components taking into account the oxygen content of Si₃N₄ or SiC powders, which is assumed to be SiO₂ on the Si₃N₄ (or SiC) particles with a density of 2.33 g/cm³.

The calculation is as follows:
SiO₂ concentration in the starting batch (c-SiO₂):

$$c \text{-} {SiO}_{2} = [ \frac{100 - ( c \text{-} Sau + c \text{-} Add )}{100} ] \cdot ( c \text{-} O \text{/} SN ) \cdot 1.88 [ wt . \% ]$$
where:
   c-Sau=sintering auxiliary concentration, wt. %
   c-Add=concentration of additives, wt. %
   c-O/SN=oxygen content of the Si₃N₄ powder, wt. %
   1.88=conversion factor oxygen/SiO₂
Si₃N₄ concentration in the starting batch (c-SN):
c-SN=100−(c-Sau+c-Add+c-SiO₂) [wt. %]
Theoretical density of e.g. the SN material (ρ-th):

$$ρ \text{-} th = \frac{100}{\frac{c \text{-} SN}{ρ \text{-} SN} + \frac{c \text{-} {SiO}_{2}}{ρ \text{-} {SiO}_{2}} + Σ ( \frac{c \text{-} Sau ( i )}{ρ \text{-} Sau ( i )} ) + Σ ( \frac{c \text{-} Add ( i )}{ρ \text{-} Add ( i )} )} , [ wt . \% ]$$

ρ-SN, —SiO₂, -Sau, -Add: pure density of the particular substance in g/cm³
Material density in percent of the theoretical density:
For this, the actual density ρ-w is determined (in g/cm³) by the known water buoyancy method (Archimedes) on the parts compacted by sintering or hot isostatic pressing (HIP) and this value is set in relation to the theoretical density ρ-th:

$$ρ \text{-} w \text{/} th = \frac{ρ \text{-} w}{ρ \text{-} th} \cdot 100 [ \% ]$$

C content:
This is determined with an automatic analyzer, e.g. CSA 2003, Leybold-Heraeus, by the oxidation method. In this, the carbon is oxidized at 1,800° C. to CO₂, the concentration of which is determined via infra-red absorption and allows calculation of the C content of the specimen. The method also allows a differentiation into free and bonded carbon.

Room temperature flexural strength (RT-FS):
This test is carried out in accordance with DIN EN 843-1 in 4-point bending with a support distance of 40/20 mm on appropriate standardized test specimens, which are produced separately from starting material identical to that of the test balls and have passed through the same thermal compaction cycles. The minimum number of flexural strength specimens to be tested is specified as 8. The values for comparison balls stated in Table 1 are brochure values.

Hardness:
This is determined on polished ground sections in accordance with DIN EN 843-4 using a small load hardness tester and a load of 10 kp (HV10).

Fracture toughness K_{iC}:
Generally, this is determined by the SEVNB method classified in a worldwide comparison study as the most reliable, described in “J. Kübler: Fracture Toughness of Ceramics using SEVNB Method: Round Robin”; VAMAS Report No. 37 (ISSN 1016-2186). However, since in general no corresponding test specimens can be produced from the roller bearing components to be evaluated, a comparison Kᵢₑ value is determined here via determination of the crack length of the Vickers hardness indentations. The evaluation is by the method of Nijhara, described in Munz, D., “Mechani sches Verhalten keramischer Werkstoffe”, Springer Verlag, Berlin 1989. A prerequisite, however, is that the E modulus and hardness are known.

Elastic constants: E modulus, G modulus, Poisson ratio μ:
The elastic constants are determined directly on balls by the RUS method (resonant ultrasound spectroscopy). In the method used, the ball to be investigated is set in oscillation by an oscillator. The oscillation amplitude is measured at the same time. By varying the stimulating frequency of the oscillator, typically in the frequency range from 100 kHz to 2 GHz, the resonance frequencies of the balls can be determined. Evaluation is by the method described in “Resonant Ultrasound Spectroscopic Techniques for Measurement of the Elastic Moduli of Solids”, A. Migliori, J. L. Sarrao, William M. Visscher, T. M. Bell, Ming Lei, Z. Fisk, and R. G. Leisure, Physica B 1, 183(1993).

Defects:
These are preferably determined on the test objects, i.e. the high-precision balls which have undergone final machining. Defects include open cracks, closed C cracks and furthermore pores and voids, metallic or other inclusions and heterogeneities, as well as diffuse optical heterogeneities which, on close analysis, prove to be an accumulation of microporosity and in Si₃N₄ materials are often called “clouds” or “spots”. 50 μm is specified as the size limit which the defect may not exceed in its largest dimension. The test is conducted visually over the entire ball surface with the aid of a magnifying glass of 50-fold magnification and suitable illumination, if appropriate after impregnation with a fluorescent liquid and UV illumination.

The most diverse material variants were characterized in respect of the criteria mentioned by the methods described and evaluated with the aid of high-precision balls of diameter ≧6 to ≦15 mm with a precision class of G5 to G25 in respect of impact strength by means of the impact test described above. Damage to the test objects of less than 50%, i.e. a maximum of 5 out of 12 possible damaged areas in the impact test described using the pendulum impact apparatus and an angle of deflection of α=40″ is chosen as the evaluation criterion. As tests for specifying the test conditions have shown, these conditions (pendulum length l=156 mm, mass of the impact hammer m=360 g, angle of deflection α=40°) lead to a clear differentiation in respect of the impact strength of various material and roller body qualities of 0-100% damage. A requirement or an evaluation criterion of 0% damage is indeed relevant in practice, but in the testing would lead to uncertainties as to whether testing is taking place in the region of the maximum impact strength of the test objects.

It has now been found that ceramic materials which contain finely divided carbon particles and have specific mechanical and elastic properties have a particularly high impact strength.

The invention therefore provides a ceramic material which has an HV10 hardness of not more than 15.5 GPa and an E modulus at room temperature of less than 330 GPa and contains 0.2 to 5 wt. % of carbon particles, the carbon particles having a maximum particle size of 5 μm.

The size of the embedded carbon particles is determined by measurement, directly or with the aid of photographs, on a polished ground section by means of a light microscope at 500-fold magnification. A suitable electronic image processing system is preferably employed. After contrast modification of a stored digitalized image, the average and maximum C particle size is evaluated e.g. with the “Image C Micro” software from Imtronic GmbH, Berlin. To obtain a statically confirmed measurement value, only the maximum C particle size is used as the criterion, whereby at least 1,000 C particles must be measured.

The materials according to the invention have an improved impact strength. For example, balls of a material according to the invention based on Si₃N₄ are damaged to the extent of less than 50% in the impact test described above using a pendulum impact apparatus and an angle of deflection of α=40°, i.e. a maximum of 5 out of 12 possible damaged areas arise, if the balls are finally machined before the impact test Such that their machined state corresponds at least to the criteria of precision class G25. The fact that the impact strength can be improved by the presence of carbon particles in the ceramic material was not to be foreseen. Rather, it would have to have been expected that the mechanical properties of a ceramic material deteriorate if this is contaminated with free carbon. The fact that materials of low hardness have a particularly high impact strength is also surprising.

The content of carbon particles is preferably 0.2 to 3 wt. %.

It is advantageous that the density of the ceramic material corresponds to at least 98.5% of the theoretical density.

In a preferred embodiment, the ceramic material is distinguished by an RT flexural strength of at least 750 MPa, a fracture toughness (K_{lC}) of at least 5.5 MPa m^{1/2} and a transverse contraction coefficient (Poisson ratio) at 25° C. of ≦0.3, the flexural strength being determined on test specimens identical in terms of material and not directly on roller bodies of the material according to the invention.

Macroscopic defects, such as open cracks, closed C cracks, pores and voids, metallic or other inclusions or—diffuse optical heterogeneities which, on close analysis, prove to be an accumulation of microporosity and in Si₃N₄ materials are often called “clouds” or “spots”, have an adverse effect on the mechanical properties of a material. In the impact test according to the specified criteria, damage in the form of the formation of critical C cracks starts at such defects. The ceramic materials according to the invention therefore preferably have no macroscopic defects which are detectable visually on a polished ball surface with the aid of suitable fluorescent penetrating inks and appropriate illumination, such as, for example, open cracks, C cracks, pores, voids and inclusions of any type of a maximum extension of >20 μm, and no diffuse optical heterogeneities of a maximum extension of ≧50 μm. The occurrence of undesirable macroscopic defects and/or optical heterogeneities substantially depends on the process conditions during preparation of the materials according to the invention. The process described below for the preparation of these materials ensures that no macroscopic defects of an extension of >20 μm and no diffuse optical heterogeneities of a maximum extension of ≧50 μm occur.

The ceramic materials according to the invention are preferably a material based on silicon nitride or zirconium dioxide, particularly preferably a material based on silicon nitride, especially preferably based on β-silicon nitride. α-SiAlON and/or SiC phases increase the hardness and/or the E modulus of ceramic materials. The materials according to the invention therefore preferably do not contain these phases in an amount greater than 35 vol. %.

A material according to the invention based on silicon nitride can additionally comprise carbide, nitride, carbonitride, boride and/or silicide compounds of the elements of groups IVB (Ti, Zr, Hf), VB (V, Nb, Ta) and VIB (Cr, Mo, W) of the periodic table and of silicon and/or iron, where the maximum size thereof may not exceed 10 μm and the maximum concentration thereof is <50 vol. %. Larger particles and/or the presence thereof in higher concentrations would have an adverse effect on the mechanical properties. These material characteristic values are determined on ceramographic ground sections by methods known to the expert, by determining the size and content of such particles by measurement, directly or with the aid of photographs, on a polished ground section at 3,000-fold magnification by means of a scanning electron microscope. A suitable manual method for this is the cut length method (lineal intercept method) known to the expert. Alternatively, a suitable electronic image processing system can be employed. A particularly favourable structural nature can be realized by addition of the finely disperse carbide, nitride, carbonitride, boride and/or silicide compounds mentioned. These compounds to the greatest extent are retained as discrete particles during preparation of the material, as a result of which, for example, the particle growth of an Si₃N₄ main phase can be influenced in a controlled manner. So that these particles do not act as failure results in the strength testing or during use of corresponding roller bodies, their maximum size may not exceed 10 μm. However, since these phases predominantly have a higher E modulus compared with Si₃N₄, their concentration must be matched to this material characteristic. In special cases the concentration can be up to 50 vol. %, and the low E modulus according to the invention can nevertheless be achieved.

In addition, sintering auxiliaries must be present. Possible sintering auxiliaries are in principle all those compounds and compound combinations which enable the specified structural features and material properties to be achieved. These include oxides of groups IIA (Be, Mg, Ca, Sr, Ba), IIIB (Sc, Y, La,), including the rare earths, and IVB (Ti, Zr, Hf) of the periodic table of the elements, as well as B₂O₃, Al₂O₃ and/or AlN and SiO₂, it being possible for the latter to be introduced simultaneously via an Si₃N₄ raw material powder, but also to be added in a targeted manner.

The materials according to the invention preferably have a combination of the structural features and material properties described as preferred.

A general specification of the structural nature in respect of particle size, particle shape, mineralogical phase content etc. can be omitted, since these parameters are reflected in the specified material properties according to the invention. On the one hand the volume ratio of the discrete, crystalline main phases to the continuous amorphous or partly crystalline grain boundary phase formed from the sintering additives and on the other hand the average particle size, the maximum particle size and the particle shape of the crystalline main phases are to be evaluated as important in this respect. In respect of the latter, rod-shaped particles having maximum thicknesses of <2 μm and maximum lengths of <10 μm are known to be favourable for materials based on silicon nitride and can be established by measures known to the expert.

The following material-related interpretation for the requirements of a ceramic material which is improved in respect of impact strength emerges from the results of the experiments carried out, this being an attempt at an explanation which does not limit the inventive idea.

The value of the elasticity modulus (E modulus) and the hardness of the material is of determining importance. The value of the Poisson ratio together with the density of the material are also important. According to the results, the E modulus should be as low as possible, and for a given material this can be influenced only within limits without further material characteristic values changing to an undesirably high degree. This influencing can thus take place via the density or residual porosity to only a very limited extent, since the strength, toughness and hardness are thereby greatly reduced. A theoretical density of >98% is advantageous for achieving the material characteristic values. However, the composite principle of multiphase materials in a combination of phases of higher and lower E moduli proves to be one possibility of reducing the E modulus. In the case of materials based on Si₃N₄, this is possible, for example, via the nature and amount of the secondary phase necessary for the sintering, which is formed from the reaction of the sintering auxiliaries added in a targeted manner and the SiO₂ content of the Si₃N₄ raw material powder and remains in the compacted material as an amorphous or partly crystalline grain boundary phase. The experiments show that these phases should preferably be present in a concentration of >10 vol. % in order to exert a significant effect on the E modulus of a material having a theoretical density of 98%.

Fine carbon particles (C particles) in the structure of the material which, as is described, can be produced via a targeted procedure according to the invention for the production process act in the same manner. However, these C particles may not reach a size above 5 μm and may be present only in a concentration of not more than 5 wt. %, so that the mechanical material properties are not adversely influenced to an undesirably high degree. On the basis of the high difference in E modulus from the matrix material, these C particles seem to have a high impact pulse-suppressing effect.

The invention furthermore provides a process for the production of materials according to the invention, in particular Si₃N₄ materials having an improved impact strength, wherein the raw materials are subjected to wet grinding and are provided with organic additives and then subjected to drying and granulation, shaping, thorough heating of the organic additives and a sintering process, preferably sintering assisted by gas pressure, the conditions being chosen such that carbon particles are separated out and no macroscopic defects larger than 20 μm and/or optical heterogeneities larger than 50 μm are formed.

To avoid the formation of macroscopic defects larger than 20 μm and/or optical heterogeneities larger than 50 μm, a procedure is preferably followed in which the suspension formed during wet grinding is freed from metallic impurities by means of a magnetic separator and sieved over a fine sieve/fine filter having a maximum sieve opening/filter pore size of 50 μm.

The raw materials for the preparation of the materials according to the invention, for example Si₃N₄ or ZrO₂, are preferably ground, deagglomerated and homogenized with a low degree of contamination as a slip based on organic solvents, such as alcohols, acetone etc. Aqueous processing, optionally with the use of suitable dispersing auxiliaries to increase the solids content of the slip, is also possible. A prerequisite for this is that no raw materials which are at risk of hydrolysis are employed and material and also process technology measures are taken such that, during granulation for conversion of the processed slip into free-flowing granules which can be pressed, no constituents are formed which are too hard and are retained during shaping and lead to undesirable defects in the sintered material or the material compacted by hot isostatic pressing.

Stirred ball mills having lining true to type and operated with grinding balls true to type are preferably employed for the processing.

A magnetic separator is preferably employed in the outer circulation of these flow-operated mills in order to remove metallic impurities.

The grinding conditions are advantageously chosen such that the particle size analysis of the processed slip, determined by known methods, such as e.g. (laser) light scattering, realized in commercially obtainable measuring apparatuses, shows a d-90 characteristic value of <1 μm, i.e. 90% of the particles are <1 μm. High-quality, finely disperse raw materials already have such values in the state in which they are employed, so that substantially only a deagglomeration and homogenization still have to be carried out. In the processing process described, a mill dwell time per kilogram of starting mixture of at least 30 minutes has proved to be appropriate for this. If relatively coarse starting substances are employed, this mill dwell time must be increased accordingly, in order to achieve a d-90 characteristic value of <1 μm. To reliably eliminate any coarse contents which may nevertheless be present and can lead to defects in the compacted material, fine filtering of the slip over a fine filter or sieve of maximum pore or sieve opening size of 50 μm after the grinding has proved advantageous and is therefore preferably carried out.

Before conversion of the slip processed according to the above into free-flowing granules which can be pressed, suitable organic additives are added to the slip as carbon-containing pressing and plastifying auxiliaries such as are conventional in ceramics, e.g. in the case of water-based slips soluble polyvinyl alcohols and acetates, polyglycols, higher fatty acids, acrylates etc., and in the case of solvent-based slips polyvinylpyrrolidone, polyglycols, oleic acid etc. These processing auxiliaries are usually volatilized without residue in air at temperatures of <700° C., and for this reason their total concentration is to be limited to a total of preferably <10 wt. %. In the process procedure according to the invention, they are broken down in a thorough heating process in air at not more than 400° C. or under an inert gas or in vacuo at not more than 800° C. into C-rich compounds which are no longer volatile and which, during the later sintering process or during the hot isostatic pressing (HIP process) under inert conditions, form finely disperse C particles.

The granulation, i.e. the conversion of the slips into free-flowing granules which can be pressed, is preferably carried out by spray drying in air or in explosion-proof installations which have been rendered inert, depending on the slip medium. It is important that this process is carried out such that hard agglomerates and encrustations which lead to defects in the later material are not formed in the dryer. Temperatures of the air or inert gas as the drying medium of <200° C. have proved appropriate in this respect. Sieving of the dried granules at <150 μm to remove coarser and usually harder granules and encrustations has additionally proved appropriate.

Shaping of the desired parts can be carried out by various conventional processes in the field of ceramics, and the isostatic pressing process under pressures of more than 1,000 bar is preferably employed for this.

Before the compaction by sintering or hot isostatic pressing, the organic processing auxiliaries added must be heated thoroughly, as described above. It is important here for the conditions to be chosen such that non-oxidic, inorganic additives and/or sintering auxiliaries consciously added are not oxidized and, by the process procedure according to the invention, formation of the C-rich compounds as a precursor of the finely disperse C particles in the compacted material occurs. The thorough heating is preferably carried out in air at not more than 400° C. or under an inert gas or in vacuo at not more than 800° C., the pressing and plastifying auxiliaries added being broken down into C-rich compounds which are no longer volatile.

After an intermediate working which is optionally to be carried out, the shaped bodies are compacted by heat treatment. The heat treatment is preferably carried out in a two-stage sintering-HIP process under inert conditions, the exact process conditions being adapted to the composition and compaction characteristics of the material to be compacted. The sintering stage is thus to be designed in respect of temperature and time such that the stage of closed porosity, which corresponds to a density of ≧93% of the theoretical density, is achieved under an N₂ pressure of as far as possible <10 bar. The conditions of the subsequent high pressure stage are preferably chosen such that with the assistance of an N₂ gas pressure of up to 100 bar in the case of gas pressure sintering or of >1,000 bar in the case of HIP, a density of ≧98.5% of the theoretical density and the desired structural nature in respect of particle size distribution and particle shape are achieved. Guideline values for these conditions are mentioned in the examples. After this compaction stage, the parts are predominantly fed to final machining in order to realize the target components.

For the preparation of materials according to the invention based on Si₃N₄, a procedure is preferably followed in which Si₃N₄ powder and sintering auxiliaries, preferably Y₂O₃ or Y₂O₃ and Al₂O₃, optionally with the addition of a dispersing auxiliary, are processed to a slip having a solids content of preferably 30 to 70 wt. %. The content of sintering auxiliaries here is preferably 5 to 20 wt. %, based on the total solids content of the slip. The slip is subjected to wet grinding and thereby deagglomerated and homogenized. Suitable carbon-containing pressing and plastifying auxiliaries are then added to the slip as organic additives. Soluble polyacrylates, polyvinyl alcohols and/or polyglycols are preferably added to water-based slips, and polyvinylpyrrolidone is preferably added to solvent-based slips. The pressing and plastifying auxiliaries are preferably employed in an amount of 1 to 10 wt. %, based on the total solids content of the slip. To avoid undesirable macroscopic defects and optical inhomogeneities, during processing of the slip it is necessary to remove magnetic metallic impurities by means of a magnetic separator and to remove any coarse contents which may be present by fine filtering of the slip over a fine filter or sieve of not more than 50 μm pore or sieve opening size after the grinding. The mixture is then subjected to a drying and granulation and a shaping, the drying preferably being carried out in a spray dryer at temperatures below 200° C. This is followed by the thorough heating, according to the invention, of the organic additives. The thorough heating process is carried out in air, preferably at temperatures of <400° C. for a duration of 0.5 to 4 h, or under an inert gas or in vacuo at temperatures of <800° C. for a duration of 0.5 to 4 h. Finally, the thoroughly heated shaped bodies are sintered. The sintering is preferably carried out in a two-stage process, wherein in the first stage (sintering stage) the shaped body is preferably treated for 0.5 to 5 h at a temperature of up to 2,000° C. under an N₂ or inert gas pressure of 1 to 50 bar, and in the second stage (gas pressure stage) it is treated for 0.5 to 2.5 h at a temperature of up to 2,000° C. under an N₂ or inert gas pressure of 50 to 2,500 bar. Particularly preferably, in the first stage (sintering stage) the shaped body is preferably treated for 0.5 to 3 h at a temperature of up to 1,900° C. under a pressure of 2 to 20 bar, and in the second stage (gas pressure stage) it is treated for 0.5 to 2.0 h at a temperature of up to 1,900° C. under a pressure of up to 2,000 bar.

For the preparation of materials according to the invention based on ZrO₂, a procedure is preferably followed in which ZrO₂ powder and sintering auxiliaries, optionally with the addition of a dispersing auxiliary, are processed to a slip, the slip is subjected to wet grinding and polyacrylates, polyvinyl alcohols, polyglycols and/or polyvinylpyrrolidone are added to the slip as organic additives, the mixture formed is then subjected to a drying and granulation and a shaping, the drying being carried out at temperatures below 250° C., the organic additives are then heated thoroughly at temperatures of between 100 and 400° C. for a duration of 0.5 to 4 h in air or between 100 and 800° C. for a duration of 0.5 to 4 h in an inert atmosphere or in vacuo and, finally, the thoroughly heated shaped body formed is sintered in a two-stage process, wherein in the first stage the shaped body is treated for 0.5 to 5 h at a temperature of up to 1,700° C. under an N₂ or inert gas pressure of 1 to 50 bar and in the second stage it is treated for 0.5 to 2.5 h at a temperature of up to 1,700° C. under an N₂ or inert gas pressure of 50 to 2,500 bar.

The ceramic materials according to the invention can be used in diverse ways. Uses in fields where the ceramic components are subjected to a high impact stress are preferred. Use as valves in engine construction, tool inserts in shaping processes (cold and hot shaping) and of cutting and machining tools with a discontinuous cut may be mentioned by way of example. The ceramic materials are preferably employed as roller bodies in bearings, for example as balls in ball bearings, which are used in plant construction, in vehicle construction and in air and space travel.

### EXAMPLES

### Example 1a

### Si₃/N₄—1a (Comparison Example)

5 wt. % Y₂O₃ and 5 wt. % Al₂O₃ were added to commercially available Si₃N₄ powder, prepared by the imide process and having a specific surface area of 14 m²/g, an O content of 1.5 wt. %, a C content of 0.1 wt. % and a total of other impurities of <200 ppm, the Y₂O₃ being a commercially available product from H. C. Starck, Goslar (grade C), and the Al₂O₃ being a commercially available product from Alcoa (CT3000SG quality). 2 wt. % TiN (H. C. Starck, grade C) was additionally added to control the formation of the structure. Using the commercially available dispersing auxiliary KV5080 (Zschimmer & Schwarz, Lahnstein), an aqueous slip having a solids content of 60 wt. % was prepared and was deagglomerated and homogenized in an Si₃N₄-lined stirred ball mill with Si₃N₄ grinding balls such that every 1 kg of solid experienced a mill dwell time of 1 h. After this grinding, 0.5 wt. % polyvinyl alcohol (PVA) (type Moviol 4-88) and 2 wt. % polyethylene glycol PEG 2000 were added to the slip as an organic binder and plastifying auxiliary and the slip was sieved over a sieve of 150 μm mesh width and dried by means of a spray dryer at tower temperatures of 220° C. to give free-flowing granules, which were sieved again to <150 μm before shaping.

Ball blanks for a final diameter of 12.7 mm and shaped bodies for producing flexural strength specimens were produced from these granules by an isostatic pressing process and were heated thoroughly in air at 350° C. The blanks treated in this way were compacted in a 2-stage sintering-HIP cycle, the sintering stage being carried out at 1,850° C. for 1.5 h under 10 bar N₂ and the HIP stage being carried out at 1,800° C. for 1 h under 2,000 bar N₂. The shaped bodies reached a density of >98.5% of the theoretical density. After the sintering, a C residue of 0.3 wt. % remained in the material and the maximum C particle size, determined by means of image evaluation as described, was 3.8 μm. The further results of the characterization of the material and balls, the latter after machining to balls of a precision better than G25, are listed in Table 1. As the values listed show, the material and test specimens predominantly have the criteria according to the invention, but due to the process a number of macrodefects are present, resulting inter alia from grinding residues and hard granules formed by the spray drying, leading to failure in the specified impact test. The material and process consequently are not according to the invention.

### Example 1b

### Si₃N₄—1b

Retaining the raw materials of Example 1a, the processing was carried out in an organic medium, i.e. a slip having a solids content of 40 wt. % was prepared in isopropanol, deagglomeration and homogenization were carried out by means of an Si₃N₄-lined stirred ball mill with Si₃N₄ grinding balls, during this flow-operated processing a magnetic separator being installed in the outer circulation, and, after the grinding, the slip was pumped through a fine filter of 50 μm pore size. 3 wt. % of the organic binder polyvinylpyrrolidone (PVP), dissolved in isopropanol, was added to this slip before this was dried by means of an explosion-proof spray dryer at tower temperatures of 180° C. to give free-flowing granules, which again were sieved to <150 μm before shaping.

Ball blanks for a final diameter of 12.7 mm and shaped bodies for flexural strength specimens were again produced from these granules and were heated thoroughly in air at a temperature of 350° C. The shaped bodies obtained were compacted as in Example 1a in the sintering-HIP process under identical conditions and then characterized. A C residue of 0.3 wt. % remained and the maximum C particle size, determined by means of image evaluation as described, was 3.6 μm. As the characteristic values listed in Table 1 show, all the criteria according to the invention are met. The modified processing employing a magnetic separator and with filtering of the slip through a fine filter of 50 μm pore size after the grinding, and the reduced spray tower temperature also lead to the absence of the macrodefects observed in Example 1a. In the specified impact test, C cracks occur only to an extent such that they qualify this material as impact-resistant according to the specific criteria. This confirms the importance of the absence of macrodefects for achieving a ceramic material of high impact strength. The material and the process for its preparation are consequently according to the invention.

### Example 1c

### Si₃N₄—1c

The starting composition, processing and shaping were carried out here in a manner identical to that in Example 1b, with the exception that the ball blanks and shaped bodies were heated thoroughly under Ar (or N₂) as the inert gas at up to 550° C. After compaction by a two-stage HIP, as described in Example 1a, 0.9 wt. % of finely disperse C particles having a maximum dimension according to the image evaluation of 4.7 μm remained in the material, without the material properties having changed significantly, as can be seen from Table 1. In the specified impact test, no C cracks at all occurred, which illustrates the positive effect of the C particles on the impact strength. The material and the process for its preparation are consequently according to the invention.

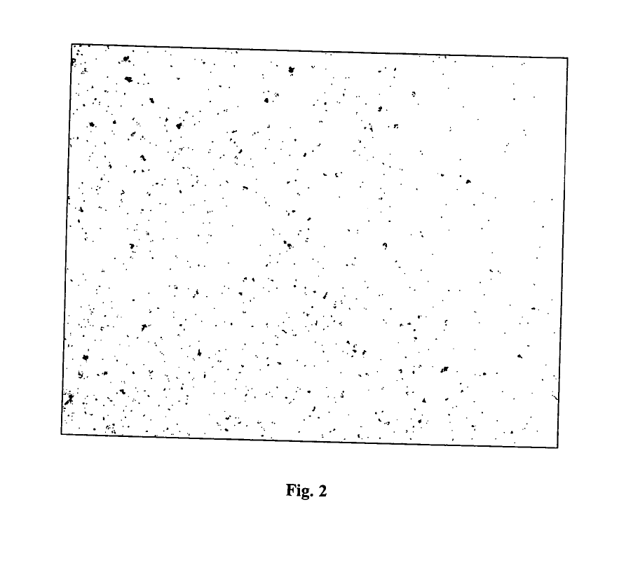

FIG. 2 shows the light microscope photograph at 500-fold magnification, after contrast modification of the stored digitalized image, of a material obtained in accordance with this example. The C particle size is determined on appropriate photographs using the “Image C Micro” software from Imtronic GmbH, Berlin. None of the 1,873 C particles evaluated had a maximum dimension greater than 5 μm. The measurement is thus confirmed statistically.

### Example 2/SN-2

Example 1b was reproduced, but in contrast to this a directly nitrided Si₃N₄ powder having a specific surface area of 5 m²/g, an O content of 0.8 wt. % and a C content of 0.3 wt. % was used. The processing was increased to a mill dwell time of 1.5 h/kg, during the flow-operated processing a magnetic separator being installed in the outer circulation, and, after the grinding, the slip was pumped through a fine filter of 50 μm pore size. Shaping, thorough heating in air and sintering-HIP compaction were carried out by processes and under conditions identical to those used in Example 1b. The properties of the resulting material and of the products produced therefrom are listed in Table 1, and meet the criteria according to the invention. In the specified impact test, C cracks occurred only to an extent which qualifies this material as impact-resistant according to the specified criteria. This illustrates that in achieving the material and component criteria according to the invention and in using the specified preparation process, the nature of the raw material is of minor importance. The material and the process for its preparation are according to the invention.

### Example 3

### Si₃N₄—3

1.4 wt. % MgO and 3.6 wt. % Al₂O₃ in the form of a precipitated spinel powder MgAl₂O₄ having a specific surface area of 20 m²/g and a content of impurities of <200 ppm and 2 wt. % SiO₂ of the Aerosil® type having a specific surface area of approx. 80 m²/g and a content of impurities of <100 ppm were added to commercially available Si₃N₄ powder M11 (H. C. Starck), prepared by direct nitriding and having a specific surface area of 12 m²/g, an O content of 1.6 wt. %, a C content of 0.1 wt. % and a total of other impurities of <200 ppm, the mixture was dispersed in isopropanol to give a slip having a solids content of 40 wt. % and the slip was then deagglomerated and homogenized in an Si₃N₄-lined stirred ball mill with Si₃N₄ grinding balls such that each 1 kg of solid experiences a mill dwell time of 1 h. This processing process was carried out with flow through the mill, a magnetic separator through which the slip pumped in circulation flowed continuously being installed in the outer circulation. After this grinding treatment, the slip was pumped once through a fine filter of 50 μm pore size in order to remove larger agglomerates which had not been broken down, and 3 wt. % of the organic binder PVP, dissolved in isopropanol, was added. This slip was dried by means of an explosion-proof spray dryer at a tower temperature of 180° C. to give free-flowing granules, which were also sieved at <150 μm, before shaping, in order to separate off coarse granules and/or material caked in the tower.

Ball blanks for a final diameter of 6.350 mm and shaped bodies for the later production of test specimens were shaped from these granules by an isostatic pressing process under pressures of up to 2,000 bar. These shaped parts were heated thoroughly in air at a temperature of 350° C. These blanks pretreated in this way were compacted, optionally after an intermediate treatment, in a 2-stage sintering process, wherein the first stage was carried out at a temperature of 1,700° C. under 2 bar of nitrogen for 1 h and the second stage was carried out at a temperature of 1,700° C. under 95 bar N₂ for 1 h. A theoretical density of >98% was achieved. A C content of 0.2 wt. % and a maximum C particle size of 2.8 μm were determined in this material by analysis. The further results of the characterization of the material and balls, the latter taking place after machining to a precision better than G25, are listed in Table 1. The material consequently achieves all the characteristic values specified according to the invention. In the specified impact test, C cracks occur only to an extent such that they qualify this material as impact-resistant according to the specified criteria. The nature and amount of sintering additives and the sintering process are accordingly secondary, as long as the specific material properties and the absence of defects larger than the specified limit values are achieved. The material and the process for its preparation are consequently according to the invention.

### Example 4a

### Si₃N₄—4a

Using the Si₃N₄ powder used in Example 3 and with the addition of 5 wt. % Y₂O₃ and 5 wt. % Al₂O₃, a sintering batch was processed, granulated and shaped to material specimens and ball blanks for a final diameter of 12.7 mm, and these were heated thoroughly in air and sintered, as described in Example 3. In this case, however, a 2-stage gas pressure sintering process was used, comprising a first stage at 1,850° C. under 10 bar N₂ for 1.5 h and a second stage at 1,750° C. under 95 bar N₂ for 1 h, which proved appropriate from the aspect of avoiding optical heterogeneities. The resulting properties and the C content determined by analysis and the maximum C particle size, listed in Table 1, show that this material achieves the criteria specified as according to the invention. In the impact test described, C cracks occur only to an extent which qualifies this material as impact-resistant according to the specified criteria. The material and the process for its preparation are consequently according to the invention.

### Example 4b

### Si₃N₄—4b (Comparison Example)

In an attempt to further increase the sintered density of the Si₃N₄ materials obtained according to example 4a and thereby to improve the material properties, the identical material was sintered with an increase in the conditions of the second sintering stage to 1,800° C. under 95 bar over a 3 h holding time. As the values listed in Table 1 show, this has an adverse effect on the material properties. The formation of large-area optical heterogeneities, which are regarded as responsible for an extent of damage in the impact test which no longer renders possible qualification as impact-resistant according to the specified criteria of this invention, is critical. The material and the process for its preparation are consequently not according to the invention.

### Example 5

### Si₃N₄—5

Since roller bearing components of higher electrical conductivity are of interest for conductive discharge of charges, such a material is synthesized and characterized in respect of its impact strength. The starting batch here comprised the commercially available Si₃N₄ powder M11 (H. C. Starck), to which 44 wt. % TiN (grade C, H. C. Starck), 8 wt. % SiC (UF25, H. C. Starck) and 5 wt. % Y₂O₃ (grade C, H. C. Starck) and 3 wt. % Al₂O₃ (CT 3000 SG, Alcoa) were added. In an identical manner to Example 3, this batch was processed, granulated and shaped into material specimens and ball blanks for a final diameter of 12.7 mm, and these were heated thoroughly in air at 350° C. The sintering was carried out under conditions identical to those described in Example 4a. A content of free, non-bonded carbon of 0.4 wt. % and a maximum C particle size of 4.3 μm were then determined. The resulting material properties, listed in Table 1, show that these meet the criteria according to the invention. In the specified impact test with finally machined balls having a diameter of 12.7 mm and a machined quality better than G25, no damage at all occurred, so that this material is to be qualified as impact-resistant. The material and the process for its preparation are consequently according to the invention.

### Example 6

### SiAlON (Comparison Example)

Using the Si₃N₄ powder M11 used in Example 4 and with the addition of 6 wt. % Y₂O₃ and 6 wt. % AlN, a batch was processed as described in Example 3, shaped to material specimens and ball blanks for a final diameter of 12.7 mm, and these were heated thoroughly in air at 350° C. Sintering was carried out by a process identical to that described in Example 4a, and the residual C content was determined as 0.3 wt. %. Due to the choice of the starting powders, in particular the use of AlN, a content of about 50 vol. % of an α-SiAlON phase known to be of higher hardness compared with β-Si₃N₄ was formed, this being determined by means of X-ray diffraction analysis. The resulting material properties, listed in Table 1, show that the hardness of the material lies outside the specified range according to the invention. When the impact test according to the description was carried out, damage to the balls occurred to an extent such it allows no qualification as impact-resistant according to the specified criteria of this invention. The material is consequently not according to the invention.

### Example 7

### Liquid Phase Sintered (LPS) SiC (Comparison Example)

6 wt. % Y₂O₃ (H. C. Starck, grade C) and 3 wt. % AlN (H. C. Starck, grade C) were added to commercially available SiC powder of UF25 quality from H. C. Starck, Goslar, having a specific surface area of 25 m²/g and an 0 content of 1.6 wt. % and the mixture was dispersed in isopropanol to give a slip having a solids content of 40 wt. %. This slip was deagglomerated and homogenized in an Si₃N₄-lined stirred ball mill with Si₃N₄ grinding balls as described for the examples given above, a magnetic separator being installed in the outer circulation of the mill. After the grinding treatment, the slip was pumped through a fine filter of 50 μm pore size, and 3 wt. % of the organic binder PVP, dissolved in isopropanol, was added. This slip was dried by means of an explosion-proof spray dryer at a tower temperature of 180° C. to give free-flowing granules, which were also sieved to <150 μm before shaping. Ball blanks for a final diameter of 6.350 mm and shaped bodies for producing test specimens were shaped from these granules as described for the Si₃N₄ examples, and these were heated thoroughly at 350° C. in air. The material pretreated in this way was subjected to a 2-stage gas pressure sintering, wherein the first sintering stage was carried out at 1,900° C. for 1 h under 10 bar N₂ and the second sintering stage at 1,850° C. under a total pressure of 100 bar, comprising 10 bar N₂+90 bar Ar, for 1 h in an oven heated by graphite resistance and with graphite insulation and a graphite crucible. The theoretical density of the sintered parts was more than 98%, the content of free, non-bonded C was 0.5 wt. % and the maximum C particle size was 6.5 μm. The other material properties determined of course differ greatly from those of the materials based on Si₃N₄. Impact tests on balls which were machined to a precision better than G25 led to a 100% formation of C cracks, so that this material is not according to the invention.

### Example 8

### Partly Stabilized ZrO₂

Granules ready for pressing, obtainable from Tosoh, for the preparation of partly stabilized ZrO₂, comprising 97 mol. % ZrO₂ and 3 mol. % Y₂O₃, were shaped to balls and shaped bodies by isostatic pressing without further pretreatment. These shaped parts were heated thoroughly in air at a temperature of 350° C. and then subjected to a sintering-HIP cycle within a graphite crucible in a graphite-insulated hot isostatic press heated by graphite resistance. The sintering stage here was carried out at 1,500° C. for 2 h under 2 bar N₂ and the HIP stage was carried out at the same temperature over 1 h under 1,000 bar N₂. A dark-coloured, dense material, the material properties of which of course differ greatly from those of the materials based on Si₃N₄ or SiC, resulted. A C content of 0.2 wt. % remained and the maximum C particle size was 2.5 μm. An impact test according to the specification carried out on balls of final dimension 6.350 mm, which were machined to a precision better than G25, led to no formation of C cracks. This material is consequently also to be regarded as according to the invention.

### Example 9

### Comparison Materials

Commercially available balls of bearing quality better than or equal to G25 having a diameter of 12.7 mm were used for these. The material properties listed for these in Table 1 are taken from the manufacturer's data or are based on measurements carried out. As example 9/C1 and C2, two Al₂O₃ materials in the form of high-precision balls, the material properties of which of course differ greatly from those of the materials described above, are tested. In particular, the elastic constants and the hardness are significantly higher than is the case for materials based on Si₃N₄. In the investigations for analysis of the structure, no C particles were found, and the C content itself lies below the detection limit of the analysis method employed of 0.05 wt. %. Both Al₂O₃ materials were damaged to 100% in the specified impact test.

As Example 9/C3 and C4, commercially available Si₃N₄ balls were tested. Not all the material and process characteristic values are available for these in the manufacturer's data. It is known of C3 that MgO is used as a sintering additive, and in C4 a combination of Y₂O₃ and Al₂O₃ is used. C4 additionally comprises a lower concentration of a finely disperse Ti—C—N phase. The RT flexural strength listed in Table 1 is taken from material data sheets, and all the other characteristic values were determined as described in the description. No C particles were found in the investigations for analysis of the structure.

Surprisingly, carrying out the impact tests with these balls led to damage on both variants which did not allow these materials to be qualified as impact-resistant according to the specified criteria of this invention. In the case of C3 the high hardness and in the case of C4 the low density and the presence of optical heterogeneities are probably responsible for this, as well as the C particles not being present in the specified amount and size in both variants.

Regardless of whether or not these explanations apply, these results confirm the knowledge on which this invention is based that a ceramic material of improved impact strength should preferably have no macroscopic defects and optical heterogeneities larger than the specified dimensions, and on the other hand must have a specific combination of material characteristic values characterized in particular by the hardness and elastic constants being below maximum values.

TABLE 1
Material characteristic values and results of the impact test

| | | | | | | | | Max C. | |
|---|---|---|---|---|---|---|---|---|---|
| | | | | | Sintered | Th. | C | particle | |
| | | Sintering | | Sintering | density | density | content | size | RT-FS |
| | Powder* | auxiliary | Additives | process | g/cm³ | % | wt % | μm | MPa |
| Ex. no.: | | | | | | | | | |
| Ex. 1, SN-1a | SN-I | Y2O3, Al2O3 | TiN | S-HIP | 3.233 | 99.2 | 0.3 | 3.8 | 870 |
| Ex. 1, SN-1b | SN-I | Y2O3, Al2O3 | TiN | S-HIP | 3.238 | 99.3 | 0.3 | 3.6 | 1050 |
| Ex. 1, SN-1c | SN-I | Y2O3, Al2O3 | TiN | S-HIP | 3.237 | 99.3 | 0.9 | 4.7 | 1020 |
| Ex. 2, SN-2 | SN-D | Y2O3, Al2O3 | TiN | S-HIP | 3.238 | 99.0 | 0.4 | 4.2 | 900 |
| Ex. 3, SN-3 | SN-G | MgO, Al2O3, SiO2 | — | GDS | 3.158 | 99.8 | 0.2 | 2.8 | 850 |
| Ex. 4, SN-4a | SN-G | Y2O3, Al2O3 | — | GDS | 3.230 | 99.6 | 0.2 | 2.7 | 965 |
| Ex. 4, SN-4b | SN-G | Y2O3, Al2O3 | — | GDS | 3.217 | 99.4 | 0.2 | n.d. | 920 |
| Ex. 5, SN-5 | SN-D | Y2O3, Al2O3 | TiN, SiC | GDS | 3.845 | 98.7 | 0.4** | 4.3 | 775 |
| Ex. 6, SiAlON | SN-D | Y2O3, AlN | — | GDS | 3.249 | 99.8 | 0.3 | 3.7 | 880 |
| Ex. 7, LPS-SiC | SiC-UF | Y2O3, Al2O3 | — | GDS | 3.237 | 98.4 | 0.5** | 6.5 | 550 |
| Ex. 8, ZrO2 | ZrO2-Y | Y2O3 | — | S-HIP | 6.050 | 97.9 | 0.2 | 2.5 | 1200 |
| Comparisons: | | | | | | | | | |
| Ex. 9, C1 | unknown | | | | 3.847 | 96.7 | <0.05 | 0 | 500 |
| Ex. 9, C2 | unknown | | | | 3.892 | 97.8 | <0.05 | 0 | 310 |
| Ex. 9, C3 | SN-? | MgO | ? | C-HIP | 3.164 | unkn. | <0.1 | 0 | 980 |
| Ex. 9, C4 | SN-I | Y2O3, Al2O3 | Ti-C-N | C-HIP ? | 3.233 | unkn. | <0.1** | 0 | 900 |

| | | | | | | | Test results: | | |
|---|---|---|---|---|---|---|---|---|---|
| | | | | | | | Number of | | |
| | Kic | | E | | | | C cracks | | According |
| | MPa | Hardness | modulus | Poisson | Ball Ø | | (n out | | to the |
| | m ½ | GPa | GPa | ratio | mm | Defects* | of 12) | % | invention? |
| Ex. no.: | | | | | | | | | |
| Ex. 1, SN-1a | 6.4 | 15.1 | 290 | 0.275 | 12.700 | macrodef. | 7 | 58 | no |
| Ex. 1, SN-1b | 6.5 | 15.2 | 297 | 0.274 | 12.700 | — | 2 | 17 | yes |
| Ex. 1, SN-1c | 6.6 | 15.0 | 294 | 0.273 | 12.700 | — | 0 | 0 | yes |
| Ex. 2, SN-2 | 5.8 | 14.8 | 295 | 0.275 | 12.700 | — | 5 | 42 | yes |
| Ex. 3, SN-3 | 6.2 | 15.2 | 298 | 0.271 | 6.350 | — | 3 | 25 | yes |
| Ex. 4, SN-4a | 6.5 | 14.8 | 302 | 0.274 | 12.700 | — | 4 | 33 | yes |
| Ex. 4, SN-4b | 6.3 | 14.9 | 289 | 0.274 | 12.700 | opt. het. | 7 | 58 | no |
| Ex. 5, SN-5 | 5.8 | 15.2 | 326 | 0.252 | 12.700 | — | 0 | 0 | yes |
| Ex. 6, SiAlON | 6.3 | 17.1 | 318 | 0.266 | 12.700 | — | 7 | 58 | no |
| Ex. 7, LPS-SiC | 4.5 | 19.5 | 445 | 0.165 | 6.350 | — | 12 | 100 | no |
| Ex. 8, ZrO2 | 10.0 | 12.0 | 205 | 0.300 | 6.350 | — | 0 | 0 | yes |
| Comparisons: | | | | | | | | | |
| Ex. 9, C1 | n.d.# | 15.7 | 357 | 0.230 | 12.700 | — | 12 | 100 | no |
| Ex. 9, C2 | n.d.# | 17.0 | 370 | 0.230 | 12.700 | — | 12 | 100 | no |
| Ex. 9, C3 | 6.0 | 16.2 | 310 | 0.269 | 12.700 | — | 12 | 100 | no |
| Ex. 9, C4 | 6.2 | 15.0 | 296 | 0.275 | 12.700 | opt. het. | 12 | 100 | no |

*SN-I = SN powder from the imide process
SN-D = SN powder from direct nitriding
SN-G = SN powder from the gas phase process
**only free carbon
#n.d. = not determined
*macrodef. = macroscopic defects >20 μm
opt. het. = optical heterogeneities >50 μm

1. A ceramic material comprising,
0.2 to 5 wt. % of carbon particles having a maximum particle size of 5 μm, wherein said ceramic material has,
an HV10 hardness of not more than 15.5 GPa, and
an E modulus at room temperature of less than 330 GPa.

2. The ceramic material of claim 1 wherein said ceramic material comprises 0.2 to 3 wt. % of carbon particles.

3. The ceramic material of claim 1 wherein said ceramic material has a density corresponding to at least 98.5% of theoretical density.

4. The ceramic material of claim 1 where said ceramic material has:
an RT flexural strength of at least 750 MPa,
a fracture toughness of at least 5.5 Mpa m^{1/2}, and
a Poisson ratio or transverse contraction coefficient at 25° C. of ≦0.3.

5. The ceramic material of claim 1 wherein said ceramic material is free of at least one of macroscopic defects larger than 20 μm and optical heterogeneities larger than 50 μm.

6. The ceramic material of claim 1 wherein said ceramic material is selected from the group consisting of silicon nitride ceramic material and zirconium dioxide ceramic material.

7. The ceramic material of claim 6 wherein said ceramic material is silicon nitride ceramic material and the ceramic material further comprises particles of at least one of carbide, nitride, carbonitride, boride and silicide compounds
of elements of groups IVB, VB and VIB of the periodic table, or
of silicon, or
of iron,
further wherein said particles have a maximum size that does not exceed 10 μm, and the maximum concentration of said particles is <50 vol. %.

8. A process of preparing a ceramic material comprising
0.2 to 5 wt. % of carbon particles having a maximum particle size of 5 μm,
wherein said ceramic material has, an HV10 hardness of not more than 15.5 GPa, and an E modulus at room temperature of less than 330 GPa, said process comprising the steps of:
providing raw materials;
subjecting the raw materials to wet grinding thereby forming wet around raw materials;
adding one or more organic additives to said wet ground raw materials, thereby forming intermediate wet around materials;
drying and granulating the intermediate wet around materials; and
shaping the dried and granulated intermediate wet around materials by means of heating and heating of the organic additives,
wherein process conditions are selected such that carbon particles are separated out, and said ceramic material is free of at least one of macroscopic defects larger than 20 μm and optical heterogeneities larger than 50 μm.

9. The process of claim 8 further comprising sieving a suspension, formed during wet grinding, over a magnetic separator and a fine filter having a maximum filter pore size of 50 μm.

10. The process of claim 9 wherein said raw materials comprise Si₃N₄ powder, sintering auxiliaries and optionally a dispersing auxiliary, and said organic additives are selected from at least one member of the group consisting of polyacrylates, polyvinyl alcohols, polyglycols and polyvinylpyrrolidone,
said process further comprising,
forming said raw materials into a slip,
wet grinding the slip,
adding said organic additives to the slip, thereby forming a mixture
drying the mixture at temperatures below 200° C.,
granulating the dried mixture,
shaping the granulated and dried mixture by heating thoroughly at temperatures of between 100 and 400° C. for a duration of 0.5 to 4 h in air, or between 100 and 800° C. for a duration of 0.5 to 4 h in an inert atmosphere or in vacuo, thereby forming a shaped body, and
sintering the shaped body by means of a two-stage process comprising a first stage and a second stage wherein
in the first stage the shaped body is treated for 0.5 to 5 h at a temperature of up to 2,000° C. under an N₂ or inert gas pressure of 1 to 50 bar, and
in the second stage the shaped body is treated for 0.5 to 2.5 h at a temperature of up to 2,000° C. under an N₂ or inert gas pressure of 50 to 2,500 bar.

11. The process of claim 9 wherein said raw materials comprise ZrO₂ powder, sintering auxiliaries, and optionally a dispersing auxiliary, and said organic additives comprise at least one member of the group consisting of polyacrylates, polyvinyl alcohols, polyglycols and/or polyvinylpyrrolidone,
said process further comprising,
processing said raw materials into a slip,
wet grinding the slip, adding said organic additives to the slip, thereby forming a mixture,
drying the mixture at temperatures below 250° C.,
granulating the dried mixture,
shaping the dried and granulated mixture by heating thoroughly at temperatures of between 100 and 400° C. for a duration of 0.5 to 4 h in air, or between 100 and 800° C. for a duration of 0.5 to 4 h in an inert atmosphere or in vacuo, thereby forming a shaped body, and
sintering the shaped body in a two-stage process comprising a first stage and a second stage, wherein
in the first stage the shaped body is treated for 0.5 to 5 h at a temperature of up to 1,700° C. under an N₂ or inert gas pressure of 1 to 50 bar, and
in the second stage it the shaped body is treated for 0.5 to 2.5 h at a temperature of up to 1,700° C. under an N₂ or inert gas pressure of 50 to 2,500 bar.

12. An article of manufacture comprising the ceramic material of claim 1 wherein said article of manufacture is selected from the group consisting of bearing roller bodies, engine valves and tool inserts.
